(19) United States
(12) Patent Application Publication
(10) Pub. No.: US 2007/0063405 A1
(43) Pub. Date: Mar. 22, 2007

(54) Clamping apparatus with a clamping holder

(75) Inventor: Ferdinand Troxler, Schenkon (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: F-Tool International AG, Oberdorfstrasse 6 (CH)

(21) Appl. No.: 11/499,962

(22) Filed: Aug. 7, 2006

(30) Foreign Application Priority Data
Sep. 21, 2005 (CH) 01537/05

(51) Int. Cl. B23Q 3/00

(52) U.S. Cl. 269/309

(57) ABSTRACT

The clamping apparatus comprises a clamping holder and a pallet releasably attachable thereto. The clamping holder is provided with first centering elements, which cooperate with second centering elements correspondingly located on the pallet in such a way that the pallet is attached to the clamping holder in a positionally well defined manner. The clamping holder, moreover, comprises two clamping elements for attaching the pallet to the clamping holder. Each clamping element has an oblique thrust surface; upon clamping the pallet to the clamping holder, the pallet is shifted in the X-Y-plane to rest on the first centering elements of the clamping holder. Simultaneously, the pallet is pulled in Z-direction towards the clamping holder and fixed thereto.

### BACKGROUND OF THE INVENTION

The present refers to a clamping apparatus for clamping a pallet or a work piece on a machine tool, comprising a clamping holder provided with first centering elements and with at least one clamping element as well as a pallet or work piece to be clamped to the clamping holder in a positionally well defined manner and provided with second centering elements. The first and second centering elements cooperate in such a way as to align the pallet or work piece with regard to the centering holder both in X- and Y-directions as well as with regard to its angular position upon clamping the pallet or work piece to the clamping holder by means of the clamping element of the clamping holder. The first centering elements of the clamping holder match the second centering elements of the pallet or work piece such that the pallet or work piece is aligned with regard to the clamping holder by moving it within the X-Y-plane upon attaching the pallet or work piece to the clamping holder.

Clamping apparatuses of the kind referred to herein serve for mounting pallets, work pieces, tools and similar elements on a machine tool in a positionally well and exactly defined manner. If a tool or a work piece has to be attached to the clamping holder, it is usually first fixed to a pallet that is subsequently attached to the clamping holder. In most cases, the clamping holder is firmly attached to the machine tool. The operation of the clamping means of the clamping holder is usually performed manually, electromechanically, pneumatically or hydraulically.

In known clamping apparatuses, the clamping holder usually comprises four centering pins, each provided with two conically running lateral surfaces. The counter part, for example in the form of a pallet, is provided with four grooves corresponding to the centering pins as far as position and shape is concerned. The pallet is provided with a centrally located draw bar by means of which it can be attached to a clamping mechanism of the clamping holder. Upon clampingly attaching the pallet to the clamping holder, the centering pins enter the centering grooves and align the pallet with regard to the clamping holder in X- and Y-directions as well as regarding its angular position around the Z-axis.

### Prior Art

The German patent document DE-C-42 13 770 discloses an apparatus for positioning a tool or a work piece with regard to a machine tool. The apparatus comprises a holder adapted to be attached to the machine tool as well as a support member for receiving the tool or work piece to be machined. For positioning the support member with regard to the holder, the support member is provided with two cylindrical pins, while the holder comprises two reference surface portions. One of the reference surface portions is V-shaped, while the other reference surface portion has a straight lateral surface. It is said that a line contact is established between the particular cylindrical pin and the assigned reference surface portion. For pressing the support member with its cylindrical pins against the holder and the two reference surface portions, respectively, in X- and Y-directions, a spring biased clamping jaw is provided. Finally, three separate screws are provided by means of which the support member is fixedly pressed to the holder in Z-direction.

The document EP 0 255 042 discloses a clamping apparatus of the kind referred to herein for attaching a tool or work piece to a machine tool. Essentially, the apparatus comprises a clamping holder and an work piece holder provided with a draw bar. The top side of the work piece holder is provided with four grooves, offset to each other by 90° around the Z-axis. In each lateral face of each groove, a narrow slot is cut to establish a lip that is elastically resilient in Z-direction. The bottom side of the clamping holder is provided with four ridges corresponding to the four grooves of the work piece holder as far as position and shape is concerned. In the region of the corners of the clamping holder, four pins are provided that serve as a Z-reference. Upon clamping the work piece holder to the clamping holder, the four ridges of the tool holder engage the elastically resilient lips and deform them axially inwards in Z-direction until the four pins serving as a Z-reference rest against corresponding surface portions of the clamping holder, with the result that the Z-position of the work piece holder is determined with regard to the clamping holder. Under the influence of the ridges engaging the elastically resilient lips, the work piece holder is positioned with regard to the clamping holder in X- and Y-directions as well as regarding the angular position around the Z-axis. In order to remove the work piece holder from the clamping holder, the work piece holder has to be raised at least by an amount corresponding to the length of the draw bar towering above the surface of the work piece holder.

### OBJECTS OF THE INVENTION

It is an object of the invention to provide a clamping apparatus of the kind referred to herein which is of very simple design and can be manufactured at low costs.

A further object of the invention is to provide a clamping apparatus of the kind referred to herein which can be operated very easily.

### SUMMARY OF THE INVENTION

To meet these and other objects, the present invention provides a clamping apparatus for clamping a pallet or a work piece on a machine tool, comprising a clamping holder provided with first centering elements and with at least one clamping element as well as a pallet or work piece to be clamped to the clamping holder in a positionally well defined manner and provided with second centering elements. The first and second centering elements cooperate in such a way as to align the pallet or work piece with regard to the centering holder both in X- and Y-directions as well as with regard to its angular position upon attaching the pallet or work piece to the clamping holder by means of the clamping element of the clamping holder. The first centering elements of the clamping holder match the second centering elements of the pallet or work piece such that the pallet or work piece is aligned with regard to the clamping holder by moving it within the X-Y-plane upon attaching the pallet or work piece to the clamping holder.

Each clamping element of the clamping holder is provided with an oblique thrust surface, and the pallet or work piece is provided with oblique clamping surfaces corresponding to the oblique thrust surfaces and cooperate therewith such that the second centering elements of the pallet or work piece are pressed in the X-Y-plane against the first centering elements of the clamping holder and simultaneously pulled in Z-direction towards the clamping holder upon attaching the pallet or work piece to the clamping holder.

Due to the fact that the particular clamping element of the clamping holder is provided with an oblique thrust surface, further due to the fact that the pallet or the work piece comprises corresponding clamping surfaces, such that the pallet or the work piece is pressed against the centering elements in the X-Y-plane and simultaneously pulled in Z-direction towards the clamping holder upon attaching the pallet or the work piece to the clamping holder, separate fixing elements can be omitted, because the clamping elements cause, besides the aligning of the pallet or work piece in the X-Y-plane, simultaneously an alignment with regard to and a fixing of the pallet or work piece to the clamping holder in Z-direction.

### BRIEF DESCRIPTION OF THE DRAWINGS

In the following, an embodiment of the apparatus according to the invention will be further described, with reference to the accompanying drawings, in which:

FIG. 1 shows a perspective, partially exploded view of a clamping holder and a pallet;

FIG. 2 shows a top view of the pallet fixed to the clamping holder;

FIG. 3 shows a cross sectional view of the clamping holder and the pallet along line A-A in FIG. 2; and

FIG. 4 shows a perspective view of the clamping holder together with a work piece adapted to be fixed thereto.

### DETAILED DESCRIPTION OF A PREFERRED EMBODIMENT

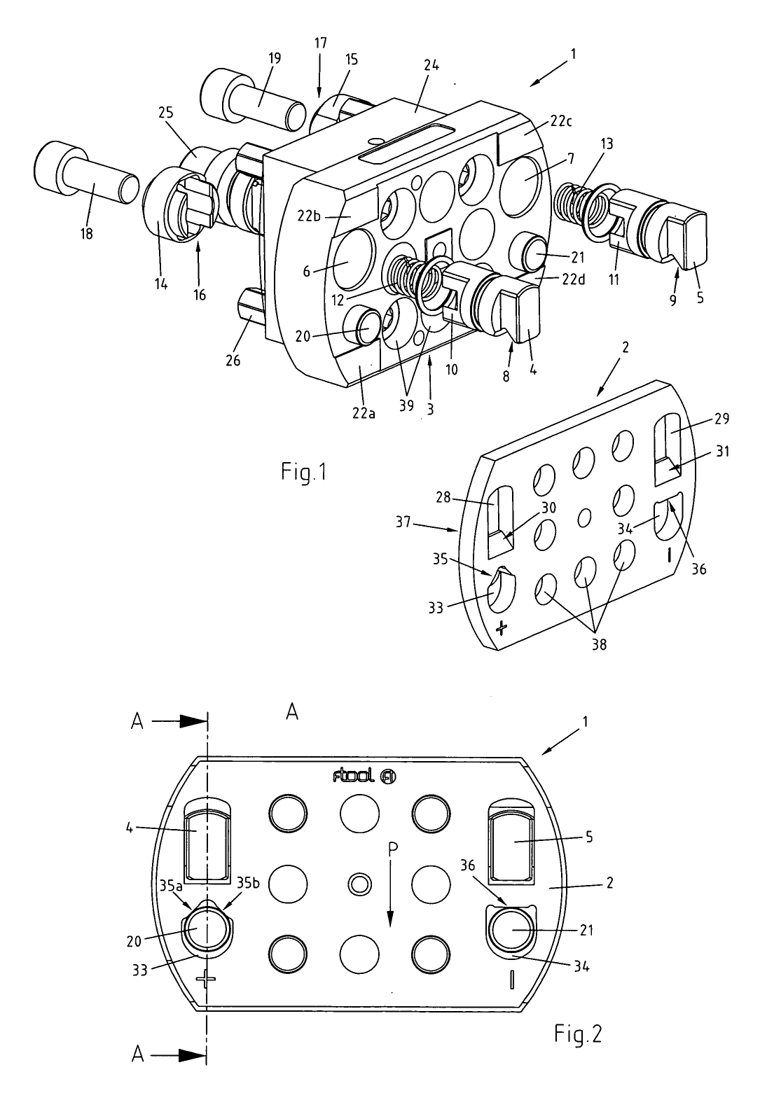

FIG. 1 shows a perspective, partially exploded view of the clamping apparatus comprising a clamping holder 1 and a pallet 2, whereby the clamping holder 1 is illustrated in a partially exploded view. The clamping holder 1 serving to fix the pallet 2 comprises two clamping elements in the form of draw studs 4, 5, located on its coupling surface 3, i.e. the surface facing the pallet 2 to be attached. The draw studs 4, 5 are received in through holes 6, 7 of the clamping holder 1. Both of the draw studs 4, 5 are provided each with an obliquely extending thrust surface 8, 9, adapted to engage a corresponding clamping surface of the pallet 2, as will be explained in detail herein below.

At the rear end of each draw stud 4, 5, a pressure spring 12, 13 is provided, adapted to push each of the draw studs 4, 5 upwards into its rest position. Each of the draw studs 4, 5 comprises an aligning surface 10, 11 in the form of lateral flat portions, located at the rear end of the draw studs 4, 5 remote from the thrust surfaces 8, 9. The draw studs 4, 5 are received in receptacles 14, 15, whereby the aligning surfaces 10, 11 ensure that they keep a predefined angular position, i.e. cannot be rotated within the receptacles 14, 15. To assist this goal, the receptacles 14, 15 are provided each with a slot 16, having a width corresponding to the width of the rear end of the aligning pins measured between the two afore mentioned aligning surfaces 10, 11. The rear end of each of the aligning pins 4, 5 is provided with a female threaded hole adapted to receive a socket head screw 18, 19, by means of which the particular draw stud 4, 5 can be pulled downwards into its operating position.

The coupling surface 3 of the clamping holder 1 is provided with first centering pins 20, 21 projecting above that surface 3. Moreover, each corner of the clamping holder 1 is provided with a slightly embossed contact surface 22a, 22b, 22c, 22d, constituting a support surface in Z-direction upon clamping the pallet 2 to the clamping holder 1. The rear side of the clamping holder 1 is provided with an adapter plate 24, having not shown centering elements, a draw bar 25 as well as support pins 26. This adapter plate serves for fixing the clamping holder 1 to a chuck system (not shown) provided on a machine tool. If appropriate, the adapter plate shown in the drawings can be omitted if the clamping holder 1 is fixed directly to a suitable support, for example to a machining table.

The pallet 2 provided with a flat rear surface comprises two longitudinal fixing apertures 28, 29. One of their lateral surfaces has a shape corresponding to the shape of the afore mentioned clamping surfaces 30, 31 and is adapted to be engaged by the particular draw stud 4, 5 with its thrust surface 8, 9. Moreover, the pallet 2 is provided with further centering elements constituted by two centering apertures 33, 34. The position, size and configuration of these centering apertures 33, 34 corresponds to the particular centering pin 20, 21 of the clamping holder 1. The first centering aperture 33 designated with a “+” sign serves for centering the pallet 2 in X- and Y-directions, while the second centering aperture 34 designated with a “−” sign serves for centering the pallet 2 regarding its angular position around the Z-axis. The first centering aperture 33 has a V-shaped lateral surface at the side 35 facing the adjacent fixing aperture 28, while the second centering aperture 34 has a straight running lateral surface 36 at the side facing the adjacent fixing aperture 29. The two centering apertures 33, 34 are located roughly on the longitudinal central axis of the adjacent fixing apertures 28, 29, whereby the longitudinal central axis of the one fixing aperture 28 runs parallel to the longitudinal central axis of the other fixing aperture 29. Additionally, the pallet 2 is provided with a plurality of fixing holes 38 serving to attach a work piece or several work pieces to the pallet 2. The clamping holder 1, on the other hand, is provided with cavities in the shape of recesses 39, such that these cavities can receive fixing means like heads of screws used to attach work pieces or tools to the pallet and inserted into the fixing holes 38 of the pallet 2.

The diameter of the two centering apertures 33, 34 and the distance between the two centering apertures 33, 34 is chosen such that the pallet 2 can be shifted in the X-Y-plane once it is loosely attached to the clamping holder 1. In order to enable the pallet 2 to be attached to the clamping holder 1, the two draw studs 4, 5 have to be in their upper rest positions; this is accomplished by loosening the two socket head screws 18, 19. The two draw studs 4, 5 being in their upper rest positions, the upper edge of the thrust surface 8, 9 of the particular draw stud 4, 5 is located above the top side of the particular centering pin 20, 21 to such an extent that the pallet 2 can be laterally slid on and swiveled away, respectively. The two draw studs 4, 5 being in their upper rest positions, the pallet 2 can be set onto the clamping holder 1 from above, such that the two draw studs 4, 5 pass through the corresponding fixing apertures 28, 29. Then, the pallet 2 is laterally shifted to such an extent that the two centering apertures 33, 34 are located above the two centering pins 20, 21 of the clamping holder 1. Subsequently, the pallet 2 is pushed downwards towards the clamping holder with the result that each of the centering pins 20, 21 of the clamping holder 1 enters the corresponding centering apertures 33, 34 of the pallet 2.

As already mentioned before, the pallet 2 can be laterally shifted in the X-Y-plane as long as it is only loosely attached to the clamping holder 1, such that an alignment of the pallet 2 with the clamping holder 1 is performed when the centering pins 20, 21 of the clamping holder 1 enter the corresponding centering apertures 33, 34 of the pallet 2. Preferably, the centering apertures 33, 34 of the pallet 2 are matched to the centering pins 20, 21 of the clamping holder 1 in such a way that a slight clearance exists between the afore mentioned centering elements 20, 21; 33, 34, with the result that the pallet 2 can be late ally moved in the X-Y-plane with regard to the clamping holder 1 as long as the pallet 2 is only loosely attached to the clamping holder 1.

Upon tightening the two draw studs 4, 5, their thrust surfaces 8, 9 engage the corresponding clamping surfaces 30, 31 of the corresponding fixing aperture 28, 29 to pull the pallet 2 downwards towards the clamping holder 1. On the other hand, the oblique configuration of the clamping surfaces 30, 31 and of the thrust surfaces 8, 9 causes the pallet 2 to be shifted in the X-Y-plane and pressed against the two centering pins 20, 21. Thereby, the one centering pin 20 rests on the two V-shapedly running lateral surface portions 35a, 35b of the first centering aperture 33 to align the pallet in X- and Y-directions, while the second centering pin 21 rests on the lateral surface 36 of the second centering aperture, i.e. that surface facing the adjacent fixing aperture 29, to thereby align the pallet with regard to its angular position around the Z-axis. During the afore mentioned lateral shifting of the pallet 2 with regard to the clamping holder 1, the flat rear surface 37 preferably already rests on the contact surfaces 22a, 22b, 22c, 22d of the clamping holder 1.

It is understood that pneumatic, hydraulic or electromagnetic operating means could be provided for the two draw studs 4,5 instead of the manual operating means in the form of the two socket head screws 18, 19.

FIG. 2 shows a top view of the pallet 2 attached to the clamping holder 1. Under the influence of the oblique thrust surfaces 8, 9 of the two draw studs 4, 5, engaging in each case corresponding clamping surfaces 30, 31 of the pallet 2, the pallet 2 is pulled downwards in Z-direction towards the clamping holder 1 upon tightening the socket head screws 18, 19, and simultaneously laterally shifted in direction of the arrow P to be pressed against the two centering pins 20, 21. Eventually, the one centering pin 20 rests on the two lateral surfaces 35a, 35b of the V-shapedly narrowing centering aperture 33 and, thereby, positions and aligns the pallet 2 with regard to the clamping holder 1 in X- and Y-directions. The other centering pin 21 eventually rests on the straight lateral surface 36 of the second centering aperture 34 to thereby determine the position of the pallet 2 with regard to its angular position around the Z-axis. Upon final tightening of the two socket head screws 18, 19, the flat rear surface of the pallet 2 comes to a rest on the four contact surfaces 22a, 22b, 22c, 22d of the clamping holder 1 (FIG. 1); thereby, also the position of the pallet 2 with regard to the clamping holder 1 is determined in Z-direction. Both the absolute accuracy and the repetitive accuracy of the position of the pallet 2 with regard to the clamping holder 1 is in the region of ± a few thousandths of a millimeter.

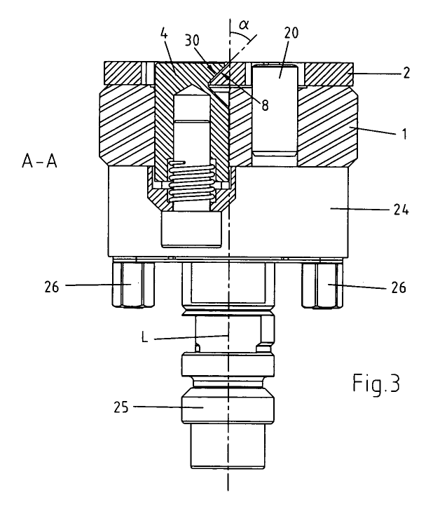

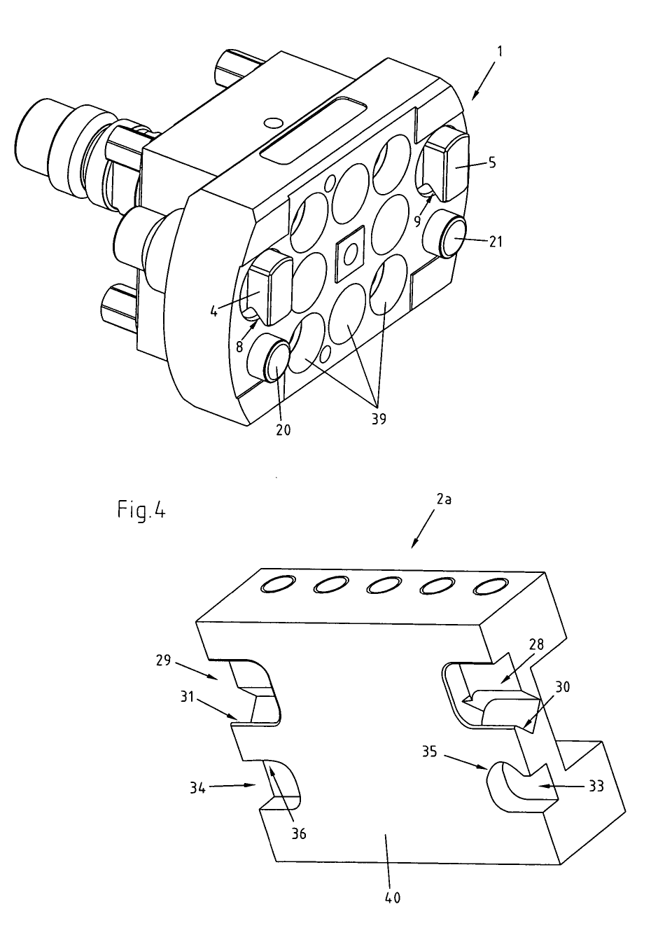

FIG. 3 shows a cross sectional view of the clamping holder 1 and the pallet 2 along line A-A in FIG. 2. In this illustration, it is particularly well visible how the oblique thrust surface 8 of the draw stud 4 engages the corresponding clamping surface 30 of the pallet 2. The oblique thrust surface 8 of the draw stud 4 encloses an angle (α) of approximately 45° with the central longitudinal axis, running in Z-direction, of the clamping holder 1. However, depending on situation and requirements, the angle (α) can amount to between 30° and 60°. Also visible in this illustration are the draw bar 25, two of the four support pins 26 as well as the centering pin 20, anchored in the clamping holder 1 by means of a press fit.

FIG. 4 shows a perspective view of the clamping holder 1 and of a counter part 2a adapted to be fixed to the holder 1. The counter part 2a can be either a work piece or an adapter or a work piece holder like a pallet; however, in the following, reference will be made to a work piece 2a to simplify matters.

In the case of the work piece 2a shown in FIG. 4, a pallet can be omitted because the elements essential for fixing to and accurate positioning of the work piece 2a with regard to the clamping holder 1 are directly provided at the two opposite edge portions of the flat rear surface 40 of the work piece 2a. Thereby, the two fixing apertures 28, 29 are designed in such a way that the head of the assigned draw stud 4, 5 can be received therein. Each of the two fixing apertures 28, 29 is provided with an oblique clamping surface 30, 31 which is adapted to be engaged by the thrust surface 8, 9 of the assigned draw stud 4, 5. Again, one of the centering apertures, i.e. the first centering aperture 33, has a V-shapedly running lateral wall portion 35 at the side facing the adjacent fixing aperture 28, while the other centering aperture 34 comprises a straight lateral surface 36 at the side facing the adjacent fixing aperture 29.

A clamping apparatus designed in a way as described herein above offers high reliability as well as high absolute and repetitive accuracy. Moreover, the clamping apparatus is of relatively simple design and can be manufactured at low costs. Also the operation is very simple, since the clamping means, i.e. the draw studs 4, 5, cause both an alignment of the position of the pallet and the work piece, respectively, with regard to the clamping holder in the X-Y-plane as well as, simultaneously, an alignment of the position of the pallet and the work piece, respectively, with regard to the clamping holder in Z-direction and also a reliable fixation of the pallet and the work piece, respectively, to the clamping holder.

Finally, it is noteworthy that the rear side of the pallet and the work piece, respectively, can be kept flat with the result that it can be easily laid down on a work bench or fixed to a machining table of a machine tool. A further big advantage may be seen in the fact that the pallet and the work piece, respectively, has to be provided with only four apertures of the kind described herein above, i.e. the two fixing apertures and the two centering apertures, in order to fix it in a well defined position to the clamping holder. Particularly the centering elements of the pallet and the work piece, respectively, constituted in the present example by the two centering apertures 33, 34 described herein above, can be machined quickly, simply and at low costs.

What is claimed is:

1. A clamping apparatus for clamping a pallet or a work piece on a machine tool, comprising:
A clamping holder provided with first centering elements and with at least one clamping element;
An element adapted to be clamped to said clamping holder in a positionally well defined manner and provided with second centering elements;
Said first and second centering elements cooperating to align said element to be clamped with regard to said centering holder both in X- and Y-directions as well as with regard to its angular position upon clamping said element to be clamped to said clamping holder by means of said at least one clamping element of said clamping holder, said first centering elements of said clamping holder matching said second centering elements of said element to be clamped such that said element to be clamped is aligned with regard to said clamping holder by moving it within the X-Y-plane upon attaching said element to be clamped to said clamping holder;
Each of said at least one clamping element of said clamping holder being provided with an oblique thrust surface, and said element to be clamped being provided with oblique clamping surfaces corresponding to said oblique thrust surfaces and cooperating therewith such that said second centering elements of said element to be clamped are pressed in the X-Y-plane against said first centering elements of said clamping holder and simultaneously pulled in Z-direction towards said clamping holder upon clamping said element to be clamped to said clamping holder.

2. A clamping apparatus according to claim 1 in which each of said at least one clamping element of said clamping holder is provided with an oblique thrust surface that includes an angle of between 30° and 60° with the central longitudinal axis, running in the direction of the Z-axis, of said clamping holder.

3. A clamping apparatus according to claim 1 in which each of said at least one clamping element of said clamping holder is provided with an oblique thrust surface that includes an angle of between 40° and 50° with the central longitudinal axis, running in the direction of the Z-axis, of said clamping holder.

4. A clamping apparatus according to claim 1 in which said first centering elements of said clamping holder match said second centering elements of said element to be clamped such that there a certain amount of clearance is present in the X-Y-plane between said second centering elements of said element to be clamped and said first centering elements of said clamping holder upon loosely attaching said element to be clamped to said clamping holder, whereby said first centering elements of said clamping holder are adapted to rest against said second centering elements of said element to be fixed by shifting said element to be fixed in the X-Y-plane.

5. A clamping apparatus according to claim 1 in which said first centering elements of said clamping holder comprises at least two centering pins and in which said second centering elements of said element to be fixed comprise at least two centering apertures, one of said centering apertures comprising two rest surfaces offset to each other for aligning said element to be clamped in X- and Y-direction with regard to said clamping holder, and an other one of said centering apertures comprising one rest surface for aligning said element to be clamped with regard to its angular orientation around the Z-axis.

6. A clamping apparatus according to claim 1 in which said clamping holder is provided with two centering pins and said element to be clamped with two centering apertures, and in which said clamping holder is provided with two clamping elements, one of said two clamping elements exerting a force on said element to be clamped in a direction towards a first one of said two centering pins of said clamping holder and the other one of said two clamping elements exerting a force on said element to be clamped in a direction towards a second one of said two centering pins of said clamping holder upon attaching said element to be clamped to said clamping holder.

7. A clamping apparatus according to claim 1 in which said element to be clamped is provided with a flat rear surface, said clamping holder comprising at least three contact surfaces on which said flat rear surface rests upon said element to be clamped has been attached to said clamping holder.

8. A clamping apparatus according to claim 1 in which said clamping holder comprises two clamping elements and said element to be clamped is provided with two mounting apertures adapted to receive said two clamping elements of said clamping holder, whereby each of said mounting apertures of said element to be clamped is provided with one of said oblique clamping surfaces, adapted each to be engaged by one of said oblique thrust surfaces of said two clamping elements of said clamping holder.

9. A clamping apparatus according to claim 6 in which one of said two centering apertures of said element to be clamped comprises a V-shapedly running lateral surface portion on which one of said two centering pins of said clamping holder rests upon clamping said element to be clamped to said clamping holder to thereby align said element to be clamped in X- and Y-directions with regard to said clamping holder.

10. A clamping apparatus according to claim 1 in which said element to be clamped is constituted by a pallet.

11. A clamping apparatus according to claim 1 in which said element to be clamped is constituted by a work piece.

12. A clamping apparatus according to claim 5 in which said clamping holder is provided with two centering pins and said element to be clamped with two centering apertures, and in which said clamping holder is provided with two clamping elements, one of said two clamping elements exerting a force on said element to be clamped in a direction towards a first one of said two centering pins of said clamping holder and the other one of said two clamping elements exerting a force on said element to be clamped in a direction towards a second one of said two centering pins of said clamping holder upon attaching said element to be clamped to said clamping holder.
